(19) United States
(12) Patent Application Publication
(10) Pub. No.: US 2026/0084082 A1
(43) Pub. Date: Mar. 26, 2026

(54) COMBUSTION AIR DELIVERY DEVICE SYSTEM FOR FRYERS WITH FILTER CLOGGING MEASUREMENT AND AUTOMATIC ADOPTION OF AIRFLOW TO COMPENSATE

(71) Applicant: FRYMASTER LLC, New Port Richey, FL (US)

(72) Inventors: Eric Pitchford, Shreveport, LA (US); Jan Claesson, Land O' Lakes, FL (US); Douglas S. Jones, New Port Richey, FL (US)

(73) Assignee: FRYMASTER LLC., New Port Richey, FL (US)

(21) Appl. No.: 19/339,576

(22) Filed: Sep. 25, 2025

Related U.S. Application Data
(60) Provisional application No. 63/698,786, filed on Sep. 25, 2024.

(51) Int. Cl. B01D 46/00; B01D 46/44; B01D 46/46; F23L 5/02; F23N 3/08

(52) U.S. Cl. CPC B01D 46/0086; B01D 46/446; B01D 46/46; F23L 5/02; F23N 3/082; B01D 2273/30; F23N 2225/06

(57) ABSTRACT

A process for controlling a combustion air delivery system of an oil fryer, the process comprising: (i) activating the combustion air delivery system; (ii) determining if a current target RPM is able to activate an air pressure sensing switch of the combustion air delivery system; (iii) if the current target RPM is able to activate the air pressure sensing switch, then a heating controller uses the current target RPM for heating; and (iv) if the current target RPM is not able to activate the air pressure sensing switch due to fan filter clogging or any other reduction in air supply in the combustion air delivery system, then the process for controlling the combustion air deliver system will conduct an initial calibration sequence to determine a new higher target RPM which will increase the air supply in the combustion air deliver system.

### CROSS-REFERENCED APPLICATION

This application is a conversion of US Provisional Application, Ser. No. 63/698,788, filed on Sep. 25, 2024, which is incorporated herein by reference thereto in its entirety.

### BACKGROUND

### 1. Field

A fryer system and method for automatically controlling a combustion air delivery device system with a removable filter element and periodically measuring filter life remaining while automatically changing air delivery device speed (i.e., RPM) to compensate for air delivery device filter clogging in order to maintain the desired airflow and also extend the useful life of the air delivery device filter. This disclosure can also be used to warn the user of required air delivery device filter maintenance before the filter element becomes completely clogged which reduces potential for system downtime.

### 2. Discussion of the Background Art

Conventional systems which incorporate combustion air delivery devices and air delivery device filters are typically not designed to adjust the air delivery device speed (RPM) to maintain the required airflow and/or compensate for the amount of filter clogging. These devices typically use an air safety switch to determine a minimum airflow required for safe combustion using a static preset air delivery device speed. In these systems, as the air delivery device filter becomes clogged, the airflow from the air delivery device is reduced proportionally until the safety switch no longer detects the proper amount of airflow or pressure. This means that there is no warning or measurement of filter life remaining prior to system shutdown which then requires maintenance of the filter element before normal operation can be restarted.

Such conventional systems that utilize air delivery and air delivery device filters do not compensate for the air delivery device filter clogging, do not warn the user prior to the end of the filter life, and would result in increased down time potential

The present disclosure also provides many additional advantages, which shall become apparent as described below.

### SUMMARY

The present disclosure is capable of automatically adjusting the air delivery device flow to achieve consistent air for a combustion system of a fryer while also filtering the supply air and monitoring the amount of clogging of the air delivery device filter element or supply air. The system is capable of alerting the user before the system is no longer able to operate effectively while also extending the useful life of the filter element by compensating for the loss of supply air through increased RPM control.

A combustion air delivery system of an oil fryer, the device comprising: a heating controller; an air delivery device; a fan comprising a fan filter, wherein the air delivery device uses pulse width modulation and RPM tachometer feedback to control the desired RPM of the air delivery device; and an air pressure sensing switch having a positive pressure port which is connected to an outlet adapter of the air delivery device to measure the air pressure produced by the air delivery device, wherein the air pressure sensing switch is electrically connected to the heating controller, thereby determining the status of at least one pressure switch contact.

The status of the pressure switch contact is determined continuously. The RPM of the air delivery device required to activate the air pressure sensing switch is determined by the heating controller. The heating controller determines the RPM of the air delivery device required to activate the air pressure sensing switch by an air delivery device calibration sequence which establishes an initial new filter condition which is 100% filter life remaining. During the air delivery device calibration sequence, the maximum available RPM of the air delivery device is determined by running the air delivery device at 100% using the pulse width modulation control and the tachometer feedback.

The desired activation setting of the air pressure sensing switch is predetermined based on a required airflow of the heating system.

A process for controlling a combustion air delivery system of an oil fryer, the process comprising: activating the combustion air delivery system; determining if a current target RPM is able to activate an air pressure sensing switch of the combustion air delivery system; if the current target RPM is able to activate the air pressure sensing switch, then a heating controller uses the current target RPM for heating; and if the current target RPM is not able to activate the air pressure sensing switch due to fan filter clogging or any other reduction in air supply in the combustion air delivery system, then the process for controlling the combustion air deliver system will conduct an initial calibration sequence to determine a new higher target RPM which will increase the air supply in the combustion air deliver system.

The process further comprises the step of comparing the new higher target RPM to an original 100% filter life remaining RPM and maximum allowable RPM establish in the initial calibration sequence.

The process further conducts a subsequent new filter life remaining RPM is generated for each subsequent calibration sequence and stored in the heating controller.

The process also comprises the step of generating a warning to alert a user to conduct a cleaning of the fan filter clogging or any other reduction in air supply in the combustion air delivery system if the filter life remaining RPM approaches a pre-determined value less than 100%.

Moreover, if there is no longer any available the air delivery device RPM capacity to reliably make the air pressure sensing switch activate, then the process will lockout and send an error alert to perform the required maintenance or replacement of the fan filter.

The process further comprises the step of determining a new filter life remaining value after cleaning the air delivery device's fan filter or correcting any other reduction in air supply in the combustion air delivery system.

The fan calibration sequence comprises the following:
a. determining the fan target RPM;
b. starting the fan;
c. detecting an activation speed of a fan switch;
d. if the fan switch is opened, then return to step (c);
e. if the fan switch is closed, then measure the speed of the fan and determine if the fan switch activation RPM is stable;
f. if not stable, then find the fan switch de-activation speed and decrease the speed of the fan and check to see if the fan switch is opened;
g. if opened, then increase the fan speed in step (c);
h. if fan switch in step (e) is not stable, then measure the fan speed;
i. determining the target RPM;
j. increasing the fan speed to a maximum;
k. measure the fan speed in step (j); and
l. determining the maximum fan speed.

The process further comprises a process for checking the fan comprising:
m. running a fan check using the current target RPM;
n. checking if the air pressure sensing switch is closed;
o. if open and the fan filter clogging has increased, then run the fan calibration sequence to determine the new higher target RPM which replaces the current target RPM and calculate the filter life remaining and return to step (m);
p. if made, then determine if the fan filter clogging is stable or not increased or reduced, then use the current target RPM for the heating.

The process further comprises determining the filter life remaining which comprises:
a. running the initial fan calibration sequence;
b. if a new filter, then 100% the filter life remaining;
c. if a subsequent fan calibration sequence, the calculate a new filter life remaining;
d. determine if less than the filter life remaining and issue a warning %;
e. if no warning % is issued, then return to step (c);
f. if warning % is issued, then display warning and allow the heating
g. determining if zero filter life remaining;
h. if there is filter life remaining, then return to step (c); and
i. if zero filter life remains, then issue an error and lock out.

Further objects, features and advantages of the present disclosure will be understood by reference to the following drawings and detailed description.

### BRIEF DESCRIPTION OF THE DRAWINGS

FIG. 1 is a combustion system according to the present disclosure.

FIG. 2A is a logic diagram according to the present disclosure pertaining to the fan calibration process.

FIG. 2B is a logic diagram according to the present disclosure pertaining to the fan check process.

FIG. 2C is a logic diagram according to the present disclosure pertaining to the filter life remaining warning and lock out process.

### DETAILED DESCRIPTION OF THE PREFERRED EMBODIMENT

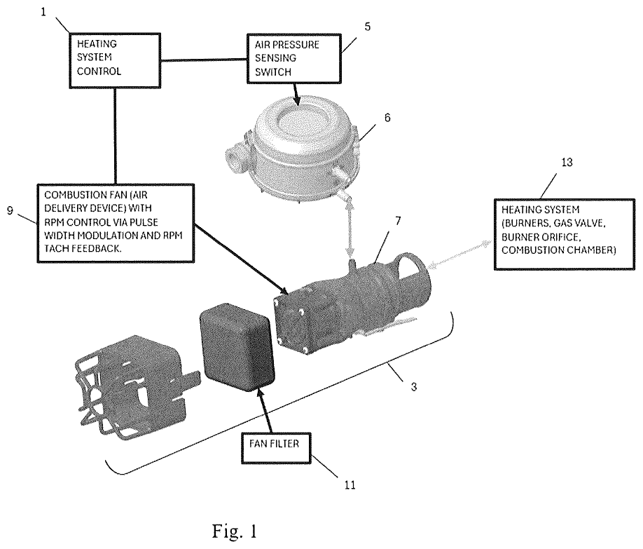

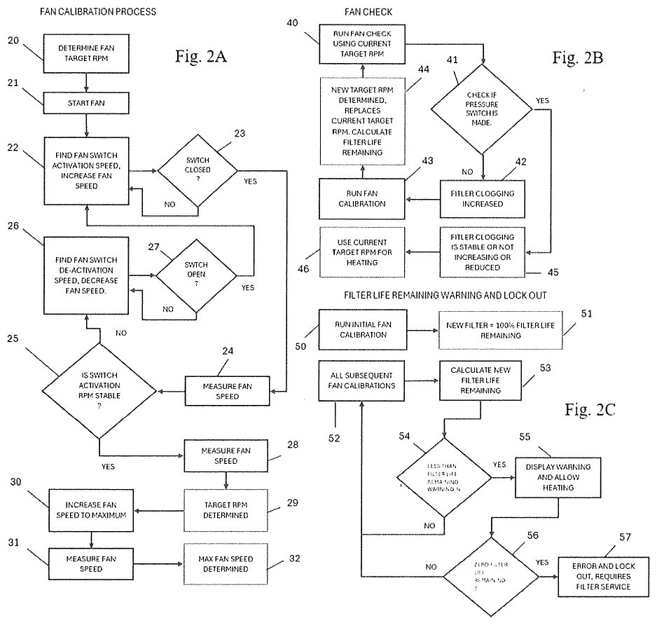

As show in FIG. 1, the present disclosure uses a microprocessor heating system control 1 that is able to power a combustion air delivery device 3 using pulse width modulation and RPM tachometer feedback from air delivery device 3 to precisely control the desired RPM of combustion air supply device 3. The positive pressure port 6 of air pressure sensing switch 5 is connected to air delivery device outlet adapter 7 so that it can directly measure the air pressure produced by air delivery device 3 during operation. Air pressure sensing switch 5 is electrically connected to heating system control 1 so that the status of the pressure switch contacts (open or closed, not shown) can be determined continuously. Using the predetermined calibration process of FIG. 2A, heater control system 1 determines the precise air delivery device rpm required to activate air pressure sensing switch 5. This process is called the air delivery device calibration sequence and this switch activation RPM is used to establish the initial new filter condition which is called 100% filter life remaining. Also, during the air delivery device calibration sequence, the maximum available air delivery device RPM is determined by running the air delivery device 3 at 100% using the pulse width modulation control and tachometer feedback 9 to determine the maximum RPM available. The desired air pressure sensing switch activation setting is predetermined based on the required airflow of the heating system.

During normal use of the air delivery device 3 for heating, this activation RPM is increased slightly in order to reliably activate air pressure sensing switch 5 and maintain the desired airflow. This is called the Target RPM. Each time heating system control 1 is turned on, the system will determine if the current target RPM is able to activate air pressure sensing switch 5. This process is called the air delivery device check. If air delivery device 3 check is successful, heater system control 1 uses the current target RPM for heating and the desired air flow is supplied. If air delivery device 3 check is unsuccessful, due to filter 11 clogging or any other reduction in air supply, then the system will conduct another calibration sequence per FIG. 2A to determine a new higher target RPM. The new target RPM is achieved by increasing the RPM of air delivery device 3, which will increase the airflow.

As the filter or supply air become increasingly restricted/clogged, the system will increase the air delivery device 3 target RPM required to make the air pressure sensing switch 5 activate reliably. As the process repeats and subsequent calibrations are completed and the RPM is increased, the new target RPM is compared to the original 100% filter life remaining RPM and maximum allowable RPM, established during the first calibration cycle. A new filter life remaining calculation is done at each subsequent calibration and stored in heating system control device 1 to be displayed or viewed at any time. As the filter life remaining value approaches a pre-determined value (less than 100%), a warning can be shown to alert the user to conduct a cleaning of fan filter 11 prior to the system shutdown due to complete loss of air flow caused by a fully clogged fan filter 11. This process will continue until there is no longer any available air delivery device 3 RPM capacity to reliably make the air pressure sensing switch 5 activate. The heating system 13, i.e., burners, gas valve, burner orifice, combustion chamber.

At this point, the system will lockout and result in an error alert that will prompt the user to perform the required maintenance or replacement of fan filter 11. After cleaning the air delivery device's fan filter 11 or correcting the air flow reduction, the subsequent calibration sequence will be used to determine a new filter life remaining value and the system will be allowed to heat normally.

The system is designed to allow for the cleaning and or replacement of the air delivery device filter 11 or the air delivery device 3 to re-establish the baseline RPM target.

FIG. 2A is a logic diagram demonstrating the fan calibration process, wherein step 20 determines the fan target RPM followed by step 21 which starts the fan. Thereafter, step 22 determines the fan switch activation speed and increases the fan speed. The process then determines if the switch is closed 23. If not closed, then it returns to step 22. If closed, then it measures fan speed 24 and then determines if the switch action RPM is stable 25. If switch activation RPM is not stable, then the process activates the fan switch de-activation speed and decreases fan speed 26. Thereafter, the process determines if the switch is open 27. If not open, then it returns to step 26. If the switch is open, then it returns to step 22 and increase the fan speed.

If step 25 determines that the switch activation RPM is stable, then it measures fan speed 28, and determines the target RPM 29 and increases the fan speed to a maximum 30. Thereafter, the process measures the fan speed 31 and determines maximum fan speed 32. After the fan calibration is completed, the heating system controller uses the new target RPM to control the air delivery device to deliver the proper air flow on all subsequent calls for heat. The air delivery device is controlled by the heating control system using a feedback loop which uses the air delivery device tachometer output and modulates the air delivery device RPM using pulse width modulation. The combustion supply air flows through the air delivery filter and is cleaned prior to entering the air delivery device. The air supplied by the fan is then allowed to flow into the heating system where it is used by the combustion system to produce heat via the combustion process.

FIG. 2B provide a logic diagram for checking the fan, wherein the fan is checked using current target RPM 40 and determines if pressure switch is closed 41. If pressure switch is open, then the process accesses that filter clogging has increased 42 and runs the fan calibration process 43 discussed in FIG. 2A. Based upon the results of fan calibration in step 43, the process then determines a new target RPM which replaces current target RPI and calculates the remaining filter life 44. Thereafter, the new target RPM returns to step 40 as the “current” target RPM. However, if pressure switch is closed 41, then the filter clogging is stable, i.e., neither increased nor reduced 45. As such, the process can use the current target RPM for heating 46.

FIG. 2C is a logic diagram for generating a filter life remaining and lock out signal. For an initial fan calibration 50 with a new filter there is 100% filter life remaining 51. For all subsequent fan calibrations 52, the process calculates a new filter life remaining 53. Thereafter, the process decides whether it needs to send a less than filter life remaining warning percentage 54. If no warning needs to be sent, then the process returns to step 52. If, however, a warning percentage needs to be sent, the process displays a warning and allows heating 55. The process then seeks to determine if zero filter life is remaining 56, and if there is filter life remaining, then the system returns to step 52. If no filter life is remaining, then the process displays an “error and lock out”message, thus requiring filter service 57.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed IS:

1. A combustion air delivery system of an oil fryer, said device comprising:
a heating controller;
an air delivery device;
a fan comprising a fan filter, wherein said air delivery device uses pulse width modulation and RPM tachometer feedback to control the desired RPM of said air delivery device; and
an air pressure sensing switch having a positive pressure port which is connected to an outlet adapter of said air delivery device to measure the air pressure produced by said air delivery device, wherein said air pressure sensing switch is electrically connected to said heating controller, thereby determining the status of at least one pressure switch contact.

2. The system according to claim 1, wherein the status of said pressure switch contact is determined continuously.

3. The system according to claim 1, wherein the RPM of said air delivery device required to activate said air pressure sensing switch is determined by said heating controller.

4. The system according to claim 3, wherein said heating controller determines the RPM of said air delivery device required to activate said air pressure sensing switch by an air delivery device calibration sequence which establishes an initial new filter condition which is 100% filter life remaining.

5. The system according to claim 4, wherein during said air delivery device calibration sequence, the maximum available RPM of said air delivery device is determined by running said air delivery device at 100% using said pulse width modulation control and said tachometer feedback.

6. The system according to claim 3, wherein a desired activation setting of said air pressure sensing switch is predetermined based on a required airflow of said heating controller.

7. A process for controlling a combustion air delivery system of an oil fryer, said process comprising:
activating said combustion air delivery system;
determining if a current target RPM is able to activate an air pressure sensing switch of said combustion air delivery system;
if said current target RPM is able to activate said air pressure sensing switch, then a heating controller uses said current target RPM for heating; and
if said current target RPM is not able to activate said air pressure sensing switch due to fan filter clogging or any other reduction in air supply in said combustion air delivery system, then said process for controlling the combustion air deliver system will conduct an initial calibration sequence to determine a new higher target RPM which will increase said air supply in said combustion air deliver system.

8. The process according to claim 7, further comprising comparing said new higher target RPM to an original 100% filter life remaining RPM and maximum allowable RPM establish in said initial calibration sequence.

9. The process according to claim 8, further conducting a subsequent new filter life remaining RPM is generated for each subsequent calibration sequence and stored in said heating controller.

10. The process according to claim 9, further comprising generating a warning to alert a user to conduct a cleaning of said fan filter clogging or any other reduction in air supply in said combustion air delivery system if said filter life remaining RPM approaches a pre-determined value less than 100%.

11. The process according to claim 10, wherein if there is no longer any available said air delivery device RPM capacity to reliably make said air pressure sensing switch activate, then the process will lock out and send an error alert to perform the required maintenance or replacement of said fan filter.

12. The process according to claim 10, further determining a new filter life remaining value after cleaning said air delivery device's fan filter or correcting any other reduction in air supply in said combustion air delivery system.

13. The process according to claim 7, wherein said fan calibration sequence comprises the following:
a. determining the fan target RPM;
b. starting said fan;
c. detecting an activation speed of a fan switch;
d. if said fan switch is opened, then return to step (c);
e. if said fan switch is closed, then measure the speed of said fan and determine if said fan switch activation RPM is stable;
f. if not stable, then find said fan switch de-activation speed and decrease the speed of said fan and check to see if said fan switch
is opened;
g. if opened, then increase said fan speed in step (c);
h. if fan switch in step (e) is not stable, then measure the fan speed;
i. determining the target RPM;
j. increasing the fan speed to a maximum;
k. measure the fan speed in step (j); and
l. determining the maximum fan speed.

14. The process according to claim 13, further comprising a process for checking said fan comprising:
(i) running a fan check using said current target RPM;
(ii) checking if said air pressure sensing switch is closed;
(iii) if is open and said fan filter clogging has increased, then run said fan calibration sequence to determine said new higher target RPM which replaces said current target RPM and calculate the filter life remaining and return to step (i);
(iv) if made, then determine if said fan filter clogging is stable or not increased or reduced, then use said current target RPM for said heating.

15. The process according to claim 8, further comprising determining said filter life remaining which comprises:
a. running said initial fan calibration sequence;
b. if a new filter, then 100% said filter life remaining;
c. if a subsequent fan calibration sequence, the calculate a new filter life remaining;
d. determine if less than said filter life remaining and issue a warning %;
e. if no warning % is issued, then return to step (c);
f. if warning % is issued, then display warning and allow said heating g. determining if zero filter life remaining;
h. if there is filter life remaining, then return to step (c); and
i. if zero filter life remains, then issue an error and lock out.
